(19) United States
(12) Patent Application Publication
(10) Pub. No.: US 2024/0326537 A1
(43) Pub. Date: Oct. 3, 2024

(54) DAMPER COUPLER

(71) Applicant: Honda Motor Co., Ltd., Tokyo (JP)

(72) Inventors: Nathan J. ZURBRUGG, West Liberty, OH (US); ERIC J. BOETTCHER, Columbus, OH (US); PHILIP S.H. MOIR, Dublin, OH (US); BRYAN C. SLABACH, West Mansfield, OH (US); JAMISON E. WEIRUP, Marysville, OH (US); AMIT JAIN, Dublin, OH (US); DANIEL A. GROSS, Dublin, OH (US); BHARADWAJ VEERA RAGHAVAN, Powell, OH (US); Alex C. VAN NEST, Columbus, OH (US)

(21) Appl. No.: 18/192,595

(22) Filed: Mar. 29, 2023

(51) Int. Cl. B60G 13/00

(52) U.S. Cl. CPC B60G 13/003

(57) ABSTRACT

A damper coupler is provided. The damper coupler includes a first portion coupled to a first section of a body of a vehicle. The damper coupler further includes a second portion coupled to a second section of the body of the vehicle. The second portion extends through the second section and connects with a portion of a damper, which is removably coupled to the body of the vehicle. The damper coupler furthers include a first mid-portion disposed between the first portion and the second portion. The first mid-portion transfers a first load between the first portion and the second portion, to limit a shear force in the damper.

### CROSS-REFERENCE TO RELATED APPLICATIONS/INCORPORATION BY REFERENCE

This application makes reference to U.S. patent application Ser. No. 18/192,551, filed on Mar. 29, 2023, entitled DAMPER COUPLER.

The above reference application is hereby incorporated herein by reference in its entirety.

### BACKGROUND

Vehicles have dampers to absorb vibrations of the vehicle. For example, dampers may be typically coupled to parts of the vehicles, via damper bolts, to absorb vibrations of the vehicle. In certain instances, few parts of the vehicles may be formed in an angular direction to provide more space for the vehicle. Based on the angular direction of the parts of the vehicle, the dampers may be coupled to such parts, to absorb vibrations of the vehicle. In such instances, the damper bolts of the dampers may experience a shear force along the angular direction, which may potentially loosen the damper bolt.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to an embodiment of the disclosure, a damper coupler may be provided. The damper coupler may include a first portion coupled to a first section of a body of a vehicle. The damper coupler may further include a second portion coupled to a second section of the body of the vehicle. The second portion may extend through the second section and connects with a portion of a damper, which may be removably coupled to the body of the vehicle. The damper coupler may further include a first mid-portion disposed between the first portion and the second portion. The first mid-portion may transfer a first load between the first portion and the second portion, to limit a shear force in the damper.

According to another embodiment of the disclosure, a damper coupler may be provided. The damper coupler may include a first portion coupled to a first section of a body of a vehicle. The damper coupler may further include a second portion coupled to a second section of the body of the vehicle. The second portion may extend through the second section and connects with a portion of a damper, which may be removably coupled to the body of the vehicle. The second portion may transfer a first load between the first portion and the second portion, to limit a shear force in the damper.

According to another embodiment of the disclosure, a method for forming a damper coupler is disclosed. The method may include forming a first portion coupled to a first section of a body of a vehicle. The method may further include forming a second portion coupled to a second section of the body of the vehicle. The second portion may extend through the second section and connects with a portion of a damper, which may be removably coupled to the body of the vehicle. The method may further include forming a first mid-portion disposed between the first portion and the second portion. The first mid-portion may be configured to transfer a first load between the first portion and the second portion, to limit a shear force in the damper.

### BRIEF DESCRIPTION OF THE DRAWINGS

FIG. 1 is a perspective view of a damper coupler for a damper assembled in an exemplary vehicle, in accordance with a first embodiment of the disclosure.

FIG. 2 is a perspective view of a damper coupler for a damper assembled in an exemplary vehicle, in accordance with a second embodiment of the disclosure.

FIG. 3 is a perspective view of a damper coupler for a damper assembled in an exemplary vehicle, in accordance with a third embodiment of the disclosure.

FIG. 4 is a perspective view of a damper coupler for a damper assembled in an exemplary vehicle, in accordance with a fourth embodiment of the disclosure.

FIG. 5 is a flowchart that illustrates exemplary operations to form the damper coupling of FIG. 1, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The following described implementations may be found in a disclosed damper coupler. The damper coupler may include a first portion (for example, a first portion of a dowel pin) that may be coupled to a first section (for example, an inner panel of a body-in-white) of a body of a vehicle. The damper coupler may further include a second portion (for example, a second portion of the dowel pin) that may be coupled to a second section (for example, an outer panel of the body-in-white) of the body of the vehicle. The second portion may extend through the second section and connects with a portion of a damper, which may be removably coupled to the body of the vehicle. As the first portion (i.e., the first portion of the dowel pin) is coupled to the inner panel of the vehicle and the second portion (i.e., the second portion of the dowel pin) is coupled to the damper via the outer panel of the body of the vehicle, the damper coupler forms an additional support for the damper, to withstand against any shear force that may loosen the damper from the body of the vehicle.

The damper coupler may further include a first mid-portion disposed between the first portion and the second portion. The first mid-portion may be configured to transfer a first load (for example, an impact load) between the first portion and the second portion, to limit the shear force in the damper. For example, in case of a potential impact load, the mid-portion may act as an interface between the first portion and the second portion and may form a load path that may further provide the additional support for the damper, to withstand against any shear force that may loosen the damper from the body of the vehicle. In some instances, the damper coupler may also be used as a spacer between portions (such as the first portion and/or the second portion) of the body of the vehicle and the damper, and subsequently forms a tight fit between the body and the damper 108, to further limit the shear force in the damper.

Reference will now be made in detail to specific aspects or features, examples of which are illustrated in the accompanying drawings. Wherever possible, corresponding, or similar reference numbers will be used throughout the drawings to refer to the same or corresponding parts.

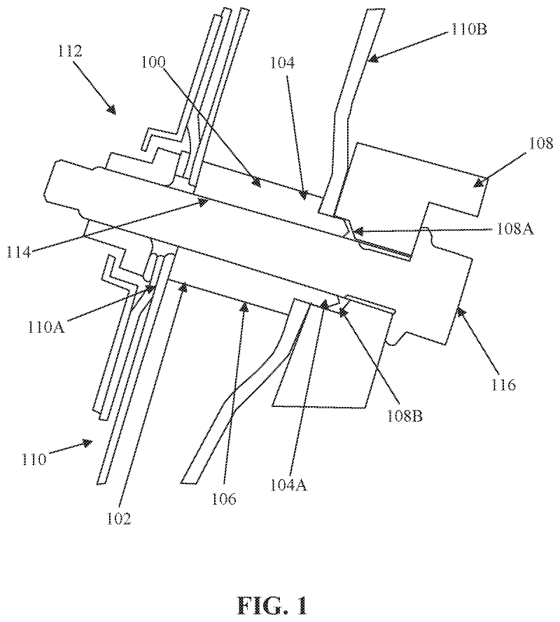

FIG. 1 is a perspective view of a damper coupler for a damper assembled in an exemplary vehicle, in accordance with a first embodiment of the disclosure. With reference to FIG. 1, there is shown a damper coupler 100. The damper coupler 100 may include a first portion 102, a second portion 104, and a first mid-portion 106. The damper coupler 100 is configured to provide an additional support for a damper 108 that may be coupled to a body 110 of a vehicle 112. In an embodiment, the first portion 102 of the damper coupler 100 may be coupled to a first section 110A of the body 110 of the vehicle 112. The second portion 104 of the damper coupler 100 may be coupled to a second section 110B of the body 110 of the vehicle 112. The second portion 104 may extend through the second section 110B and connect with a portion 108A of the damper 108, for the additional support.

The damper coupler 100 may be a supporting implement that may be configured to support the damper 108 against the body 110 of the vehicle 112. In an embodiment, the damper coupler 100 may be configured to receive shock impulses (such as vibrations) and coverts the received the shock impulses to other forms of energy, such as a linear traction or a heat generation. Examples of the damper coupler 100 may include, but not limited to, a bracket, a pin, a dowel pin, or a surface mounted collar.

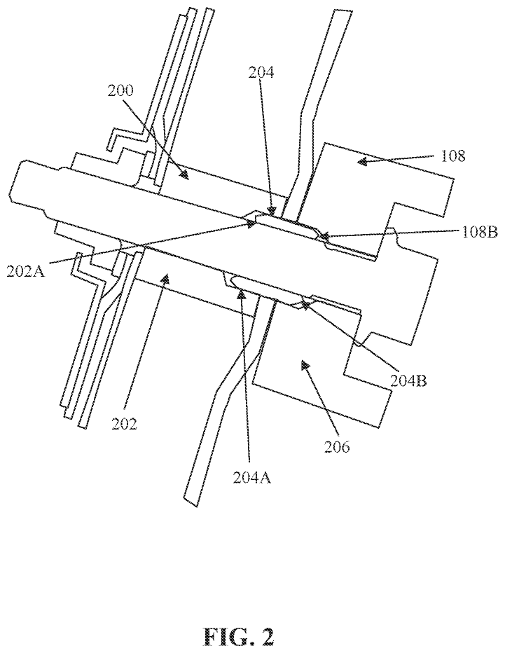

In an embodiment, the damper coupler 100 may be located between the first section 110A and the second section 110B of the body 110 of the vehicle 112. The damper coupler 100 may also extend through the second section 110B and may connect with the portion 108A of the damper 108, as shown in FIG. 1. The damper coupler 100 shown in FIG. 1 has a single part structure. However, the damper coupler 100 may also include more than one part, such as, a two-part structure, a three-part structure, a four-part structure, and the like. Description of more than one part of the damper coupler 100 is described further, for example, in FIGS. 2-4. In another embodiment, the damper coupler 100 may be connected to any part of the damper 108, based on user requirements. For example, in case the damper coupler 100 requires the support on a side surface (not shown) of the damper 108, the damper coupler 100 may be disposed on the side surface of the damper 108. In another example, in case the damper coupler 100 requires the support on a base surface (not shown) of the damper 108, the damper coupler 100 may be disposed on a top of the damper 108. Therefore, the damper coupler 100 may be disposed at any location of the damper 108 and at any location of the body 110 of the vehicle, to support the damper 108 against any shear force that may loosen the damper 108 from the body 110 of the vehicle 112.

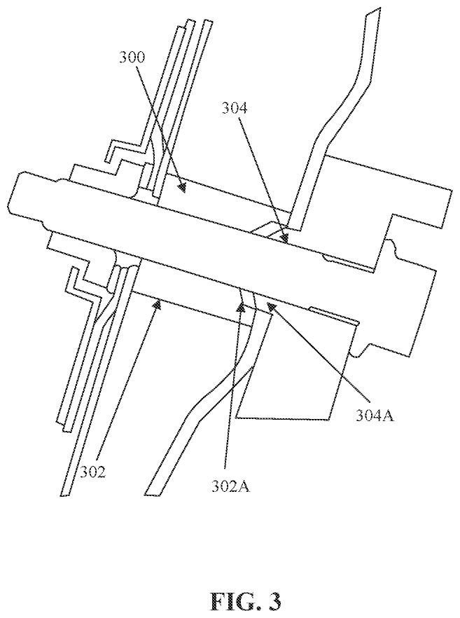

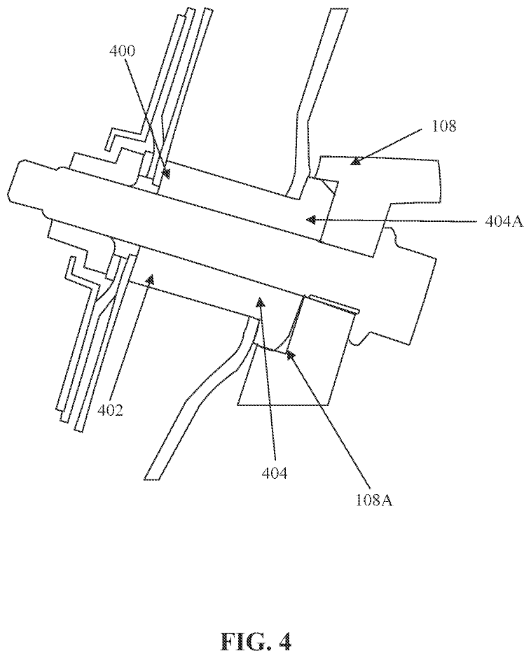

In an embodiment, the first portion 102 and the second portion 104 may form a dowel pin. For example, the first portion 102 and the second portion 104 may be combined to form a substantially cylindrical profile, such as the dowel pin a shown in FIG. 1. The cylindrical profile may couple the body 110 at one end (i.e., the first portion 102), and the damper 108 of the vehicle 112 at another end (i.e., the second portion 104), to support the damper 108 against any shear force that may loosen the damper 108 from the body 110 of the vehicle 112. In another embodiment, the first portion 102 and the second portion 104 may form one of: a separate dowel pin structure (as shown in FIG. 2), a dowel pin with integrated damper mount (as shown in FIG. 3), a surface mounted collar (as shown in FIG. 4), or a bracket (not shown). The damper coupler 100 shown as a single dowel pin in FIG. 1 is merely an example. The damper coupler 100 may also include one of: a plurality of dowel pins, a plurality brackets, and the like. For example, the first portion 102 and the second portion 104 may be combined to form twin-dowel pin (not shown). The twin-dowel pin may include a twin-head portion (not shown) and a stem portion, such that, the stem portion may be coupled to the body 110 of the vehicle 112 and the twin-head portion may be coupled to the portion 108A of the damper 108, to firmly support the damper 108 against any shear force that may loosen the damper 108 from the body 110 of the vehicle 112.

The first portion 102 may be coupled to the first section 110A of the body 110. In an embodiment, the first portion 102 may be coupled to the first section 110A as a lap joint (for example, a whole of the first portion 102 may be coupled to the first section 110A). In another embodiment, the first portion 102 may be coupled to the first section 110A as a butt joint (for example, only a part of the first portion 102 may be coupled to the first section 110A). In yet another embodiment, the first portion 102 may be coupled to the first section 110A via other fastening joints, such as, a screw component, a rivet component, and the like. In certain instances, the first portion 102 may have a first length (not shown) that may be lesser than a second length of the second portion 104. In other instances, the first portion 102 may have the first length that may be equal to the second length of the second portion 104. In yet other instances, the first portion 102 may have the first length that may be higher than the second length of the second portion 104. The length of the first portion 102 and/or the second portion may be modified based on the user requirements and design requirements. For example, in case the portion 108A of the damper 108 is smaller in length, the second portion 104 may correspondingly have the second length that may match with the length of the portion 108A of the damper 108.

In an embodiment, the first portion 102 may be formed from a substantially cylindrical structure. For example, the substantially cylindrical structure may have a first end (such as a flat end) that may conform to a structure of the first section 110A of the body 110. The substantially cylindrical structure of the first portion 102 may facilitate a uniform pressure between the first portion 102 of the damper coupler 100 and the first section 110A of the body 110 of the vehicle 112. In certain cases, the first portion 102 may be manufactured via various sheet metal processing techniques, such as, but not limited to, a rolling technique, a bending technique, a blanking technique, a trimming technique, or an embossing technique. Typically, the first portion 102 may be manufactured via the rolling technique (for example, a metallic material is fed between rollers, to form metallic sheets, which may be stamped to form the first portion 102). Further, based on user requirements, the first portion 102 may also be formed as different structures other than the substantially cylindrical structure, for example, a substantially rectangular structure, a substantially triangular structure, a substantially arcuate structure, and the like. Description of such structure is omitted from the disclosure for the sake of brevity.

In an embodiment, the first portion 102 may be symmetrical to the second portion 104. In such cases, the first portion 102 and the second portion 104 may be interchangeably deployed as the damper coupler 100 to support the damper 108. For example, instead of forming the damper coupler 100 with the first portion 102 and the second portion 104, the damper coupler 100 may be formed from two first portions (each being the first portion 102), or from two second portions (each being the second portion 104).

The second portion 104 may be coupled to the second section 110B of the body 110. In an embodiment, the second portion 104 may be extended through the second section 110B and connected with the portion 108A of the damper 108. For example, the second portion 104 may be coupled to the second section 110B and the portion 108A of the damper 108, as a lap joint (such as, a whole of the second portion 104 may be coupled to the second section 110B and the portion 108A of the damper 108). In another example, the second portion 104 may be coupled to the second section 110B as a butt joint (for example, only a part of the second portion 104 may be coupled to the second section 110B and the portion 108A of the damper 108). In yet another embodiment, the second portion 104 may be coupled to the second section 110B, via other fastening joints, such as, a screw component, a rivet component, and the like.

In an embodiment, the second portion 104 may be formed from a substantially cylindrical structure. For example, the substantially cylindrical structure may have a second end (such as a flat end) that may conform to a structure of the second section 110B of the body 110 and the portion 108A of the damper 108. The substantially cylindrical structure of the second portion 104 may facilitate a uniform pressure between the second section 110B of the body 110 and the portion 108A of the damper 108. In certain cases, the second portion 104 may be manufactured via various sheet metal processing techniques, such as, but not limited to, a rolling technique, a bending technique, a blanking technique, a trimming technique, or an embossing technique. Typically, the second portion 104 may be manufactured via the rolling technique (for example, a metallic material is fed between rollers, to form metallic sheets, which may be stamped to form the second portion 104). Further, based on the user requirements, the second portion 104 may also be formed as different structures other than the substantially cylindrical structure, such as, but not limited to, a substantially rectangular structure, a substantially triangular structure, or a substantially polygonal structure. Description of such structure is omitted from the disclosure for the sake of brevity.

In an embodiment, the second portion 104 may further include a protrusion 104A, which may extend from the second section 110B of the body 110 and connect with the portion 108A of the damper 108. In an example, the protrusion 104A may have a minimal diameter compared to a diameter of the second portion 104. In another example, the protrusion 104A may have a large diameter compared to the diameter of the second portion 104. In yet another example, the protrusion 104A may have a diameter that may be equal to the diameter of the second portion 104. The diameter of the protrusion 104A of the second portion 104 may be selected based on the user requirements. Description of variation in such diameter of protrusion 104A of the second portion 104 is further explained, for example, in FIGS. 2-4. In some embodiments, the second portion 104 may have a dowel-pin based structure (for example, via the protrusion 104A) with a first length (not shown), which may be determined based on the shear force of the damper 108. For example, the protrusion 104A may form the dowel-pin based structure which may have the first length, such that, the first length conforms/mates with the portion 108A of the damper 108 and limits any shear force in the damper 108.

The first mid-portion 106 may be disposed between the first portion 102 and the second portion 104. In an embodiment, the first mid-portion 106 may be disposed equidistant from the first portion 102 and/or the second portion 104. In another embodiment, the first mid-portion 106 may be disposed: at a first distance (not shown) from the first portion 102, and at a second distance (not shown) from the second portion 104. In certain instances, the first distance may not be same as the second distance. In other instances, the first distance may be lesser than the second distance. Based on the user requirements and the design requirements, the first mid-portion 106 may vary its positional orientation.

In an embodiment, the first mid-portion 106 may couple the first portion 102 and the second portion 104, via a cylindrical connection (such as an inline cylinder, for example, about 0 degrees). In another embodiment, the first mid-portion 106 may couple the first portion 102 and the second portion 104, via a bent connection (such as an arcuate connection, for example, at a specific radius). Based on a type of connection between the first portion 102 and the second portion 104, the first mid-portion 106 may be configured to transfer the first load between the first portion 102 and the second portion 104, such that, the transfer of the first load, may limit the shear force in the damper 108. For example, in case the first mid-portion 106 has the cylindrical connection between the first portion 102 and the second portion 104, the first mid-portion 106 may form a linear load path to transfer the first load and limit the shear force in the damper 108. In another example, in case the first mid-portion 106 has the bent connection between the first portion 102 and the second portion 104, the first mid-portion 106 may form an arcuate load path to transfer the first load and limit the shear force in the damper 108.

In an embodiment, the first portion 102, the second portion 104, and the first mid-portion 106, may be coated with a Zinc Nickel Plating with a yellow-colored passivation, for corrosion resistance of the damper coupler 100. In another embodiment, the first portion 102, the second portion 104, and the first mid-portion 106, may be coated with the Nickel Chromium passivation. Examples of other materials for passivation may include, but are not limited to, Zinc, and Titanium. Based on such passivation coating, the damper coupler 100 may have an additional oxide layer, which may improve a service life of the damper coupler 100.

In certain instances, the first portion 102, the second portion 104, and the first mid-portion 106 may have a thickness ranging from 3 micrometers to 5 micrometers. In other instances, the first portion 102, the second portion 104, and the first mid-portion 106 may have a thickness ranging from 1 micrometer to 50 micrometers. In yet other instances, the first portion 102, the second portion 104, and the first mid-portion 106 may have a thickness that may exceed beyond 50 micrometers. The first portion 102, the second portion 104, and the first mid-portion 106, shown in FIG. 1 is merely an example. It may be understood that the damper coupler 100 may also be configured as only with first portion 102 and the second portion 104, excluding the first mid-portion 106, and without deviating from the scope of invention.

In an embodiment, the damper 108 may be removably coupled to the body 110 of the vehicle 112. In an example, the damper 108 may be coupled to the second section 110B of the body 110 of the vehicle 112 and subsequently connected with the second portion 104 of the damper coupler 100. In an embodiment, the damper 108 may typically include a mechanical device (such as a cylinder and a piston arrangement) or a hydraulic device (such as a hydraulic cylinder) that may be configured to absorb the shock impulses and dampen the received shock impulses, via at least one of: the linear traction of components (such as the piston) of the damper 108, or transfer the received shock impulses via a suitable load path and dissipate such shock impulses in a form of the heat generation. The damper coupler 100 may also include other components, which may include, a pneumatic device (such as an air cylinder), an electro-magnetic device (such as a solenoid), and the like. Examples of the damper 108 may include, but are not limited to, a mono-tube damper, a twin-tube damper, or a spool valve damper.

In an embodiment, the portion 108A of the damper 108 may typically form a first slot 108B, which conforms with the protrusion 104A of the second portion 104. For example, the portion 108A of the damper 108 may form the first slot 108B with a substantially cylindrical cavity, which may be configured to receive the protrusion 104A that may be shaped to a substantially cylindrical profile. In another example, the portion 108A of the damper 108 may form the first slot 108B with a substantially rectangular cavity, which may be configured to receive the protrusion 104A that may be shaped to a substantially rectangular profile. In yet another example, the portion 108A of the damper 108 may form the first slot 108B with a substantially triangular cavity, which may be configured to receive the protrusion 104A that may be shaped to a substantially triangular profile. In yet another example, the portion 108A of the damper 108 may form the first slot 108B with a substantially polygonal cavity, which may be configured to receive the protrusion 104A that may be shaped to a substantially polygonal profile.

In some embodiments, the first slot 108B may have a first depth (not shown) that may conform to the first length of the protrusion 104A of the second portion 104. For example, if the first depth of the first slot 108B is smaller in depth, the protrusion 104A of the second portion 104 may correspondingly have a smaller length to conform/mate the protrusion 104A of the second portion 104 with the first slot 108B of the damper 108, at the portion 108A. In another example, if the first depth of the first slot 108B is larger in depth, the protrusion 104A of the second portion 104 may correspondingly have a larger length to conform/mate the protrusion 104A of the second portion 104 with the first slot 108B of the damper 108, at the portion 108A.

In some other embodiments, the first slot 108B may have a first width (not shown) that may conform to a first width (not shown) of the protrusion 104A of the second portion 104. The first width may be determined based on the shear force in the damper 108 and the protrusion 104A of the second portion 104. For example, if the first width of the first slot 108B is smaller in width, the protrusion 104A of the second portion 104 may correspondingly have a smaller width to conform/mate the protrusion 104A of the second portion 104 with the first slot 108B of the damper 108, at the portion 108A, and limit the shear force in the damper 108. In another example, if the first depth of the first slot 108B is larger in width, the protrusion 104A of the second portion 104 may correspondingly have a larger width to conform/mate the protrusion 104A of the second portion 104 with the first slot 108B of the damper 108, at the portion 108A, and limit the shear force in the damper 108.

The body 110 of the vehicle 112 may be a collection of frames that may be mechanically joined together to form a skeleton (for example, a body-in-white) of the vehicle 112. In certain situations, the collection of frames may be welded to from the body-in-white of the body 110. However, the collection of frames may also be joined based on other mechanical fastening methods, which may include, but are not limited to, a riveting method, a clinching method, a bonding method, or a laser brazing method. In some embodiments, certain parts of the body 110 may be angularly disposed to improve space in a passenger cabin (not shown) of the vehicle 112.

In certain embodiments, the first section 110A of the body 110 may be a panel (for example, an inner panel of the body-in-white) of the body 110. For example, the first section 110A may be located proximate to a passenger/driver cabin (not shown) of the vehicle 112. In certain embodiments, the second section 110B of the body 110 may be a panel (for example, an outer panel of the body-in-white) of the body 110. For example, the second section 110B may be located proximate to the first section 110A and away from the passenger/driver's cabin of the vehicle 112. In certain embodiments, the damper coupler 100 may be configured to be disposed between the first section 110A and the second section 110B and connect with the damper 108, via the protrusion 104A, as shown in FIG. 1.

The vehicle 112 may include a non-autonomous vehicle, a semi-autonomous vehicle, or a fully autonomous vehicle, for example, as defined by National Highway Traffic Safety Administration (NHTSA). In some situations, the vehicle 112 may also include a vehicle with autonomous drive capability that uses one or more distinct renewable or non-renewable power sources, such as, a fossil fuel-based vehicle, an electric propulsion-based vehicle, a hydrogen fuel-based vehicle, a solar-powered vehicle, and/or a vehicle powered by other forms of alternative energy sources. The vehicle 112 shown in FIG. 1 is merely an example of a four-wheeled vehicle. In another example, the vehicle 112 may also be a one-wheeler vehicle, a two-wheeler vehicle, or a three-wheeler vehicle. Examples of such vehicles may include, but are not limited to, an electric vehicle, an internal combustion engine (ICE)-based vehicle, or a hybrid vehicle. In yet another example, the vehicle 112 may also include a vehicle with more than four wheels, such as a lorry, truck, and the like.

In an embodiment, the damper coupler 100 may further include an annular cavity 114 that may extend between the first portion 102, the second portion 104 and the first mid-portion 106. For example, the annular cavity 114 may be a hole that may be formed in a central axis (not shown) of the first portion 102, the second portion 104, and the first mid-portion 106. In some embodiments, the annular cavity may be configured to receive a damper bolt 116 of the damper 108.

The damper bolt 116 may be a type of mechanical fastener that may be configured to secure the damper 108 on to the body 110 of the vehicle 112. The damper bolt 116 may include a plurality of male threads that may be configured to mate with a plurality of female threads on the damper 108 and the body 110 of the vehicle 112, to secure the damper 108 against the body 110 of the vehicle 112. The damper bolt 116 may be typically assembled along with a damper nut, which may be configured to secure the damper on other side of the body 110 of the vehicle 112. Examples of the damper bolt 116 may include, an arbor bolt, a carriage bolt, a hex bolt, a J-bolt, a lag bolt, a U-bolt, and the like.

In operation, the damper coupler 100 is provided. The damper coupler 100 may include the first portion 102 (for example, the first portion of the dowel pin) that may be coupled to the first section 110A (for example, the inner panel of the body-in-white) of the body 110 of the vehicle 112. The damper coupler 100 may further include the second portion 104 (for example, the second portion of the dowel pin) that may be coupled to the second section 110B (for example, the outer panel of the body-in-white) of the body 110 of the vehicle 112. The second portion 104 may extend through the second section 110B and may connect with the portion 108A of the damper 108, which may be removably coupled to the body 110 of the vehicle 112. As the first portion 102 (i.e., the first portion of the dowel pin) is coupled to first section 110A (i.e., the inner panel) of the body 110 of the vehicle 112 and the second portion 104 (i.e., the second portion of the dowel pin) is coupled to the damper 108 via the second section 110B (i.e., the outer panel) of the body 110 of the vehicle 112, the damper coupler 100 may form an additional support for the damper 108, to withstand against any shear force that may loosen the damper 108 from the body 110 of the vehicle 112.

The damper coupler 100 may further include the first mid-portion 106 disposed between the first portion 102 and the second portion 104. The first mid-portion 106 may be configured to transfer the first load (for example, an impact load) between the first portion 102 and the second portion 104, to limit the shear force in the damper 108. For example, in case of a potential impact load, the damper coupler 100 may be configured to receive vibrations from the body 110 of the vehicle 112. Based on reception of the vibrations from the body 110 on the first portion 102 of the damper coupler 100, the first mid-portion 106 may form the load path (such as the angular load path or the arcuate load path based on the structure of the first mid-portion 106) to transfer the first load between the first portion 102 and the second portion 104 and further limit the shear force in the damper 108.

In an embodiment shown in FIG. 1, the first portion 102 may be integrally coupled to the second portion 104 to form an integrated dowel pin (such as the protrusion 104A). The second portion 104 of the integrated dowel-pin may be inserted in the first slot 108B of the damper 108, to limit the shear force in the damper 108. The protrusion 104A of the second portion 104 may also have other configurations, which may be described in detail, for example, in FIGS. 2-4.

In an alternate embodiment, the damper coupler 100 may include the first portion 102 that may be coupled to the first section 110A of the body 110 of the vehicle 112. The damper coupler 100 may further include the second portion 104 that may be coupled to the second section 110B of the body 110 of the vehicle 112. The second portion 104 may extend through the second section 110B and may connect with the portion 108A of the damper 108, which may be removably coupled to the body 110 of the vehicle 112. Based on the reception of vibrations from the body 110 of the vehicle 112, the second portion 104 may be configured to transfer the first load between the vehicle 112 and the damper 108, via the first portion 102, to limit the shear force in the damper 108. For example, the damper coupler 100 may form a load path from the body 110 of the vehicle 112 to the second portion 104, via the first portion 102, to limit the shear force in the damper 108. In such embodiment, the damper coupler 100 has a minimalistic structure without any mid-portion between the first portion 102 and the second portion 104, which may eventually minimize a manufacturing cost of the damper coupler 100. In yet another embodiment, the first portion 102 and the second portion 104 may form a spacer (such as a separator) between the first section 110A and the second section 110B of the body, and subsequently form a tight fit between the body 110 and the damper 108, and further limit the shear force in the damper 108.

In another alternate embodiment, the first portion 102 or the second portion 104 has a plurality of mounting connections (such as mounting points for the damper 108 and body 110 of the vehicle 112). Each of the plurality of mounting connections may facilitate an interference fit between the damper coupler 100 and the damper 108. For example, the protrusion 104A of the second portion 104 may have one or more mounting points (such as detents, ridges, slots, or other mounting markers) to align and/or mate with the first slot 108B of the damper 108. In an embodiment, each mounting connection of the plurality of mounting connections may be independently controlled to facilitate the interference fit between the damper coupler 100 and the damper 108. For example, the protrusion 104A of the second portion 104 may have two or more mounting points (i.e., detents, ridges, slots, or other mounting markers), such that, each mounting point of the protrusion 104A may be configured to independently couple the damper coupler 100 and the damper 108, without any reference from other mounting points of the protrusion 104A of the first portion 102 of the damper coupler 100. In another embodiment, all mounting connections of the plurality of mounting connections may be cumulatively controlled to facilitate the interference fit between the damper coupler 100 and the damper 108. For example, the protrusion 104A of the second portion 104 may have two or more mounting points (i.e., detents, ridges, slots, or other mounting markers), such that, each mounting point of the protrusion 104A may be configured to cumulatively couple the damper coupler 100 and the damper 108, with reference from other mounting points of the protrusion 104A of the first portion 102 of the damper coupler 100. Therefore, the protrusion 104A may not be connected with the portion 108A of the damper 108, unless all the mounting points of the protrusion 104A are aligned/mated with the first slot 108B of the damper 108. Such arrangement may further limit shear force in the damper 108.

FIG. 2 is a perspective view of a damper coupler for a damper assembled in an exemplary vehicle, in accordance with a second embodiment of the disclosure. FIG. 2 is explained in conjunction with elements from FIG. 1. With reference to FIG. 2, there is shown a damper coupler 200 that may have a first portion 202 and a second portion 204.

The damper coupler 200 and its corresponding elements, such as the first portion 202 and the second portion 204, may be substantially same as the damper coupler 100 and its corresponding elements, such as the first portion 102 and the second portion 104, as described in FIG. 1. Hence, description of the damper coupler 200 and its corresponding elements are omitted from the disclosure for the sake of brevity.

The first portion 202 may form a first female connector 202A and may have a substantially cylindrical structure and the second portion 204 may have a dowel-pin based structure (such as a separate dowel pin 206). For example, the first portion 202 may be removably coupled to the second portion 204 to form the separate dowel pin 206. The second portion 204 of the separate dowel pin 206 may be configured to be inserted in the first slot 108B of the damper 108, to limit the shear force in the damper 108. For example, the second portion 204 may be formed as a two-part structure, for example, a first part including a substantially cylindrical structure and a second part with the separate dowel pin 206. During assembly, the substantially cylindrical structure may be disposed on the second section 110B of the body 110 and the separate dowel pin 206 of the second portion 104 may be inserted in the first slot 108B of the damper 108, to limit the shear stress in the damper 108.

The second portion 204 may have a first end 204A and a second end 204B. The first end 204A may form a first male connector, and the second end 204B may form a second male connector. The first male connector of the second portion 204 may be coupled to the first female connector 202A of the first portion 202. The second male connector of the second portion 204 may be coupled to the first slot 108B of the damper 108. For example, during assembly, the first end 204A of the second portion 204 may be coupled to the first female connector 202A of the first portion 202 and the second end 204B of the second portion 204 may be coupled to the first slot 108B of the damper 108, to couple the body 110 of the vehicle 112 and the damper 108, via the damper coupler 100, and limit the shear stress in the damper 108.

In an embodiment, the first portion 202 may have a first ramp surface, and the second portion 204 may have a second ramp surface. The first ramp surface may align with the second ramp surface, to form the separate dowel pin 206. For example, the first ramp surface may be one of: a first sloped surface or a first arcuate surface, which may be aligned/mated with the second ramp surface that may be one of: a second sloped surface or a second arcuate surface. In an embodiment, the first ramp surface may have an angular configuration that may substantially conform to an angular configuration of the second ramp surface, to further limit the shear stress in the damper 108.

In another embodiment, the first portion 202 may be formed from a first graded steel material, and the second portion 204 may be formed from a second graded steel material. In one example, the second graded steel material is different from the first graded steel material. In another example, the second graded steel material may be same as the first graded steel material. In yet another example, the second portion 204 may be formed as the twin part structure, such that, the first part with the substantially cylindrical structure may be formed from the first graded steel material and the second part with the separate dowel pin 206 may be formed from the second graded steel material. In yet another example, the damper coupler 200 may also be fabricated from other materials, such as, but not limited to, a composite material or an alloy material.

In yet another embodiment, the first portion 202 may be formed from a first coating material, and the second portion 204 may be formed from a second coating material. In an example, the second coating material may be different from the first coating material. For instance, the first portion 202 may be coated with a Zinc Nickel Plating with a yellow-colored passivation, for corrosion resistance of the damper coupler 100. The second portion 104 may be coated with the Nickel Chromium passivation. Examples of other materials for passivation may include, but are not limited to, Zinc, and Titanium. Based on different passivation coating, the damper coupler 200 may have an additional oxide layer, which may improve the service life of the damper coupler 100.

FIG. 3 is a perspective view of a damper coupler for a damper assembled in an exemplary vehicle, in accordance with a third embodiment of the disclosure. FIG. 3 is explained in conjunction with elements from FIG. 1 and FIG. 2. With reference to FIG. 3, there is shown a damper coupler 300. The damper coupler 300 may include a first portion 302 and a second portion 304.

The damper coupler 300 and its corresponding elements, such as the first portion 302 and the second portion 304 may be substantially same as the damper coupler 100 and its corresponding elements, such as the first portion 102 and the second portion 104, as described in FIG. 1. Hence, description of the damper coupler 200 and its corresponding elements are omitted from the disclosure for the sake of brevity.

The first portion 302 may have a substantially cylindrical structure. In an embodiment, the first portion 302 may form a first female connector 302A with the substantially cylindrical structure. The first portion 302 may also be formed as other structures, such as, but not limited to, a substantially triangular structure, a substantially rectangular structure, or a substantially polygonal structure. The first female connector 302A may have one of: an arcuate profile (such as a curved profile) or a chamfered profile (such as, a plurality of angular sections that forms a surface of the first female connector 302A). During, assembly, the first female connector 302A of the first portion 302 may be configured to align and/or mate with the second portion 304 of the damper coupler 300.

The second portion 304 may be formed as a protrusion, which may extend from the portion 108A of the damper 108. In an embodiment, the second portion 304 may form a first male connector 304A that may act as the protrusion that may be extended from the portion 108A of the damper 108 (shown in FIG. 1). For example, the second portion 304 may be integrally coupled to the damper 108 to form an integrated damper pin (i.e., the first male connector 304A). The first male connector 304A may have one of: an arcuate profile (such as a curved profile) or a chamfered profile (such as, a plurality of angular sections that forms a surface of the first male connector 304A). In an embodiment, the integrated damper pin of the second portion 304 may be configured to align and/or mate with the first portion 302, to limit the shear force in the damper 108.

In operation, the first male connector 304A of the second portion 304 may be coupled to the first female connector 302A of the first portion 302, to further limit the shear force in the damper 108. For example, the first male connector 304A having one of: the arcuate profile or the chamfered profile, may be aligned and/or mated with the first female connector 302A having one of: the arcuate profile or the chamfered profile. In an embodiment, the first male connector 304A and the first female connector 302A may be aligned and mated without any gap between the first male connector 304A and the first female connector 302A. In another embodiment, there may be a coupling element (such as a washer, a spacer, a thermal sealant, etc.) that may be disposed between the first male connector 304A and the first female connector 302A, for better coupling between the first male connector 304A and the first female connector 302A, to further limit the shear force in the damper 108.

FIG. 4 is a perspective view of a damper coupler for a damper assembled in an exemplary vehicle, in accordance with a fourth embodiment of the disclosure. FIG. 4 is explained in conjunction with elements from FIG. 1, FIG. 2, and FIG. 3. With reference to FIG. 4, there is shown a damper coupler 400. The damper coupler 400 may include a first portion 402 and a second portion 404.

The damper coupler 400 and its corresponding elements, such as the first portion 402 and the second portion 404, may be substantially same as the damper coupler 100 and its corresponding elements, such as the first portion 102 and the second portion 304, as described in FIG. 3. Hence, description of the damper coupler 400 and its corresponding elements are omitted from the disclosure for the sake of brevity.

The first portion 402 may have a substantially cylindrical structure and integrally coupled with the second portion 404. The first portion 402 may also be formed as other structures, such as, but not limited to, a substantially triangular structure, a substantially rectangular structure, or a substantially polygonal structure. Based on the structure of the first portion 402, the corresponding structure of the second portion 404 may vary. In one example, the first portion 402 and the second portion 404 may have same structure, such as, the substantially cylindrical profile. In another example, the first portion 402 and the second portion 404 may have different structures, based on user requirements. For instance, the first portion 402 may have the substantially cylindrical structure and the second portion 404 may have the substantially triangular structure, based on the user requirements. In an embodiment, the first portion 402 and the second portion 404 may be formed as a single-part structure with a unitary structural profile.

The second portion 404 may be formed as a protrusion (such as the protrusion 104A shown in FIG. 1). In an embodiment, the protrusion of the second portion 404 of the damper coupler 400 may have a width that may be substantially larger than a width of the protrusion 104A of the second portion 104 of the damper coupler 100. In another embodiment, the protrusion of the second portion 404 of the damper coupler 400 may have a width that may be substantially smaller than a width of the protrusion 104A of the second portion 104 of the damper coupler 100. In yet another embodiment, the protrusion of the second portion 404 of the damper coupler 400 may have a width that may be substantially equal to a width of the protrusion 104A of the second portion 104 of the damper coupler 100 (shown in FIG. 1).

In an embodiment, the protrusion of the second portion 404 may have a substantially flushed configuration with the portion 108A of the damper 108. For example, in the substantially flushed configuration, the protrusion of the second portion 404 has a first plane (not shown), which is in-line with a second plane (not shown) of the portion 108A of the damper 108. In an example, the substantially flushed configuration of the second portion 404 of the damper coupler 400, may have an increased surface area to couple the damper 108 with the body 110 of the vehicle 112 (shown in FIG. 1), as compared to a surface area of the second portion 104 of the damper coupler 100, and further limit the shear force in the damper 108.

In another embodiment, the first portion 402 may be integrally coupled to the second portion 404 to form a surface mounted collar 404A (i.e., the protrusion of the second portion 404). The second portion 404 of the surface mounted collar 404A may be configured to be inserted in the first slot 108B of the damper 108, to limit the shear force in the damper 108. In one example, the surface mounted collar 404A may have a width that may be larger than a width of the first portion 402. In another example, the width of the surface mounted collar 404A may be determined based on the width of the first slot 108B of the damper 108. In case there is an increase in width of the first slot 108B, there may be a corresponding increase in the width of the surface mounted collar 404A that may be flushed with the portion 108A of the damper 108, to further increase the surface area of contact between the damper 108 and the body 110 of the vehicle 112, to further limit the shear force in the damper 108.

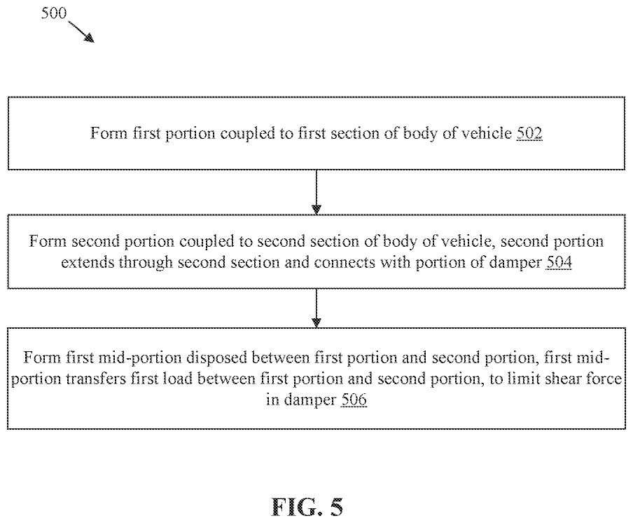

FIG. 5 is a flowchart that illustrates exemplary operations to form the damper coupling of FIG. 1, in accordance with an embodiment of the disclosure. FIG. 5 is explained in conjunction with elements from FIG. 1, FIG. 2, FIG. 3, and FIG. 4. With reference to FIG. 5, there is shown a flowchart 500. The operations from 502 to 506 may be implemented, for example, by a user or a manufacturer of the vehicle 112. The operations of the flowchart 500 may start at 502.

At 502, the first portion 102 may be formed. In an embodiment, a user, or a manufacturer of the vehicle 112 may form the first portion 102 that may be coupled to the first section 110A of the body 110 of the vehicle 112, as described further, for example, FIG. 1.

At 504, the second portion 104 may be formed. In an embodiment, the user or the manufacturer may form the second portion 104 that may be coupled to the second section 110B of the body 110 of the vehicle 112 and extends further to connect with the portion 108A of the damper 108 as described, for example, in FIG. 1.

At 506, the first mid-portion 106 may be disposed between the first portion 102 and the second portion 104. In an embodiment, the user or the manufacturer may form the first mid-portion 106 that may be disposed between the first portion 102 and the second portion 104. The first mid-portion 106 may transfer the first load between the first portion 102 and the second portion 104, to limit the shear force in the damper 108 as described, for example, in FIG. 1.

The flow chart shown in FIG. 5 is illustrated as discrete operations, such as from 502 to 506, which relates to the formation of the damper coupler 100 for the vehicle 112. However, in certain embodiments, such discrete operations may be further divided into additional operations, combined into fewer operations, or eliminated, depending on the implementation without detracting from the essence of the disclosed embodiments.

For the purposes of the present disclosure, expressions such as “including”, “comprising”, “incorporating”, “consisting of”, “have”, “is” used to describe, and claim the present disclosure are intended to be construed in a non-exclusive manner, namely allowing for items, components or elements not explicitly described also to be present. Reference to the singular is also to be construed to relate to the plural. Further, all joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

The foregoing description of embodiments and examples has been presented for purposes of illustration and description. It is not intended to be exhaustive or limiting to the forms described. Numerous modifications are possible considering the above teachings. Some of those modifications have been discussed and others will be understood by those skilled in the art. The embodiments were chosen and described for illustration of various embodiments. The scope is, of course, not limited to the examples or embodiments set forth herein but can be employed in any number of applications and equivalent devices by those of ordinary skill in the art. Rather it is hereby intended the scope be defined by the claims appended hereto. Additionally, the features of various implementing embodiments may be combined to form further embodiments.

What is claimed is:

1. A damper coupler, comprising:
a first portion coupled to a first section of a body of a vehicle;
a second portion coupled to a second section of the body of the vehicle, the second portion extends through the second section and connects with a portion of a damper, wherein the damper is removably coupled to the body of the vehicle; and
a first mid-portion disposed between the first portion and the second portion, wherein
the first mid-portion is configured to transfer a first load between the first portion and the second portion, to limit a shear force in the damper.

2. The damper coupler according to claim 1, further comprising:
an annular cavity that extends between the first portion, the second portion and the first mid-portion, wherein
the annular cavity is configured to receive a damper bolt of the damper.

3. The damper coupler according to claim 1, wherein
the first portion has a substantially cylindrical structure,
the second portion has a dowel-pin based structure, and
the first portion is integrally coupled to the second portion to form an integrated dowel pin, wherein the second portion of the integrated dowel pin is configured to be inserted in a first slot of the damper, to limit the shear force in the damper.

4. The damper coupler according to claim 3, wherein
the first slot has a first width which is determined based on the shear force in the damper.

5. The damper coupler according to claim 3, wherein
the dowel-pin based structure has a first length which is determined based on the shear force in the damper.

6. The damper coupler according to claim 1, wherein
the first portion has a substantially cylindrical structure,
the second portion has a dowel-pin based structure, and
the first portion is removably coupled to the second portion to form a separate dowel pin, wherein the second portion of the separate dowel pin is configured to be inserted in a first slot of the damper, to limit the shear force in the damper.

7. The damper coupler according to claim 6, wherein
the first portion forms a first female connector; and
the second portion has a first end and a second end, the first end forms a first male connector and the second end forms a second male connector, wherein
the first male connector of the second portion is coupled to the first female connector of the first portion, and
the second male connector of the second portion is coupled to the first slot of the damper.

8. The damper coupler according to claim 6, wherein the first portion has a first ramp surface and the second portion has a second ramp surface, and wherein the first ramp surface is configured to align with the second ramp surface, to form the separate dowel pin.

9. The damper coupler according to claim 6, wherein
the first portion is formed a first graded steel material, and
the second portion is formed from a second graded steel material, the second graded steel material is different from the first graded steel material.

10. The damper coupler according to claim 6, wherein
the first portion is formed from a first coating material, and
the second portion is formed from a second coating material, the second coating material is different from the first coating material.

11. The damper coupler according to claim 1, wherein
the first portion has a substantially cylindrical structure,
the second portion is formed as a protrusion, which extends from the portion of the damper, and
the second portion is integrally coupled to the damper to form an integrated damper pin, wherein the integrated damper pin is configured to mate with the first portion, to limit the shear force in the damper.

12. The damper coupler according to claim 11, wherein
the first portion forms a first female connector, and
the second portion forms a first male connector,
the first male connector of the second portion is coupled to the first female connector of the first portion, to limit the shear force in the damper.

13. The damper coupler according to claim 1, wherein
the first portion has a substantially cylindrical structure,
the second portion formed as a protrusion, which has a substantially flushed configuration with the portion of the damper, and
the first portion is integrally coupled to the second portion to form a surface mounted collar, wherein the second portion of the surface mounted collar is configured to be inserted in a first slot of the damper, to limit the shear force in the damper.

14. The damper coupler according to claim 13, wherein, in the substantially flushed configuration, the protrusion of the second portion has a first plane, which is in-line with a second plane of the portion of the damper.

15. The damper coupler according to claim 1, wherein the first portion and the second portion forms a spacer between the first section and the second section of the body, and subsequently forms a tight fit between the body and the damper.

16. The damper coupler according to claim 1, wherein one of: the first portion or the second portion has a plurality of mounting connections, and wherein each of the plurality of mounting connections facilitates an interference fit between the damper coupler and the damper.

17. The damper coupler according to claim 16, wherein each mounting connection of the plurality of mounting connections is independently controlled to facilitate the interference fit between the damper coupler and the damper.

18. The damper coupler according to claim 16, wherein all mounting connections of the plurality of mounting connections are cumulatively controlled to facilitate the interference fit between the damper coupler and the damper.

19. A damper coupler, comprising:
a first portion coupled to a first section of a body of a vehicle; and
a second portion coupled to a second section of the body of the vehicle, the second portion extends through the second section and connects with a portion of a damper, the damper is removably coupled to the body of the vehicle, wherein
the second portion is configured to transfer a first load between the vehicle and the damper, via the first portion, to limit a shear force in the damper.

20. A method, comprising:
forming a first portion that is coupled to a first section of a body of a vehicle;
forming a second portion that is coupled to a second section of the body of the vehicle, the second portion extends through the second section and connects with a portion of a damper, wherein the damper is removably coupled to the body of the vehicle; and
forming a first mid-portion that is disposed between the first portion and the second portion, wherein
the first mid-portion is configured to transfer a first load between the first portion and the second portion, to limit a shear force in the damper.
